(19) United States
(12) Patent Application Publication
(10) Pub. No.: US 2023/0237805 A1
(43) Pub. Date: Jul. 27, 2023

(54) VIDEO CLASSIFIER

(71) Applicant: NEC Laboratories America, Inc., Princeton, NJ (US)

(72) Inventors: Biplob Debnath, Princeton, NJ (US); Oliver Po, San Jose, CA (US); Srimat Chakradhar, Manalapan, NJ (US)

(21) Appl. No.: 18/157,915

(22) Filed: Jan. 23, 2023

Related U.S. Application Data
(60) Provisional application No. 63/302,237, filed on Jan. 24, 2022.
(60) Provisional application No. 63/412,995, filed on Oct. 4, 2022.

(51) Int. Cl. G06V 20/56; G06V 20/40; G06V 10/74; G06V 10/764; B60W 30/09

(52) U.S. Cl. CPC G06V 20/56; B60W 30/09; G06V 10/761; G06V 10/764; G06V 20/46

(57) ABSTRACT

A computer-implemented method is provided. The method includes classifying a video clip of consecutive video frames into one of predefined new classes in relation to a base training set class. The method further includes controlling a system of a motor vehicle for accident avoidance responsive to the one of the predefined classes indicating an impending collision. The classifying step includes extracting video frame features from the video clip. The classifying step further includes aggregating the video frame features of the consecutive video frames into a single frame feature to form a video level feature presentation. The classifying step also includes mapping, by a distance-based classifier, the video level feature presentation into a classification prediction based on cosine similarity.

### RELATED APPLICATION INFORMATION

This application claims priority to U.S. Provisional Pat. Application No. 63/302,237, filed on Jan. 24, 2022, and U.S. Provisional Pat. Application No. 63/412,995, filed Oct. 4, 2022, incorporated herein by reference in their entireties.

### BACKGROUND

### Technical Field

The present invention relates to video classification and more particularly to a cosine similarity based few-shot video classifier with attention-based aggregation.

### Description of the Related Art

Videos are expected to make up more than 80% of all consumer internet traffic by 2022 due to an exponentially growing number of IoT devices (such as, e.g., smart phones, robots, cars, industrial machines, and so forth) with embedded cameras. Although humans can easily understand video, or recognize and identify actions in video, automating this procedure by using computers remains an open challenge. Human action recognition in video is of interest for a wide range of applications such as automated surveillance, elderly behavior monitoring, human-computer interaction, content-based video retrieval, and video summarization.

To enable learning from only a few labeled examples, meta-learning methods have been proposed where the classification model is trained in an episodic manner to learn from limited examples of novel actions. Episodic training more closely mimics how few-shot action recognition models will be used in practice to recognize novel classes, and meta-learning methods are expected to generalize well and avoid overfitting. Although the meta-learning methods have achieved state-of-the-art (SOTA) performance, these methods leverage ImageNet pre-trained weights and often fail to focus on learning effective representations, rather they focus on learning temporal alignment for the similarity estimation.

### SUMMARY

According to aspects of the present invention, a computer-implemented method is provided. The method includes classifying a video clip of consecutive video frames into one of predefined new classes in relation to a base training set class. The method further includes controlling a system of a motor vehicle for accident avoidance responsive to the one of the predefined classes indicating an impending collision. The classifying step includes extracting video frame features from the video clip. The classifying step further includes aggregating the video frame features of the consecutive video frames into a single frame feature to form a video level feature presentation. The classifying step also includes mapping, by a distance-based classifier, the video level feature presentation into a classification prediction based on cosine similarity.

According to other aspects of the present invention, a computer program product is provided. The computer program product includes a non-transitory computer readable storage medium having program instructions embodied therewith. The program instructions are executable by a computer to cause the computer to perform a method. The method includes classifying, by a hardware processor of the computer, a video clip of consecutive video frames into one of predefined new classes in relation to a base training set class. The method further includes controlling, by the hardware processor, a system of a motor vehicle for accident avoidance responsive to the one of the predefined classes indicating an impending collision. The classifying step includes extracting video frame features from the video clip. The classifying step further includes aggregating the video frame features of the consecutive video frames into a single frame feature to form a video level feature presentation. The classifying step also includes mapping, by a distance-based classifier implemented by the hardware processor, the video level feature presentation into a classification prediction based on cosine similarity.

According to still other aspects of the present invention, a computer processing system is provided. The computer processing system includes a memory device for storing program code. The computer processing system further includes a hardware processor operatively coupled to the memory device for running the program code to perform a classification of a video clip of consecutive video frames into one of predefined new classes in relation to a base training set class. The hardware processor further runs the program code to control a system of a motor vehicle for accident avoidance responsive to the one of the predefined classes indicating an impending collision. The classification includes extracting video frame features from the video clip. The classification includes aggregating the video frame features of the consecutive video frames into a single frame feature to form a video level feature presentation. The classification further includes mapping, by a distance-based classifier implemented by the hardware processor, the video level feature presentation into a classification prediction based on cosine similarity.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 shows an exemplary system for video classification, in accordance with an embodiment of the present invention;

FIG. 3 is a block diagram showing a few-shot classification pipeline, in accordance with an embodiment of the present invention;

FIG. 4 shows an overview of a pre-training stage, in accordance with an embodiment of the present invention;

FIG. 5 shows an overview of a few-shot adaptation stage, in accordance with an embodiment of the present invention;

FIG. 6 is a flow diagram showing an exemplary method for cosine-similarity based few-shot classification with attention-based aggregation, in accordance with an embodiment of the present invention; and

FIG. 7 is a block diagram showing an exemplary environment to which the present invention can be applied, in accordance with an embodiment of the present invention.

### DETAILED DESCRIPTION OF PREFERRED EMBODIMENTS

Embodiments of the present invention are directed to a cosine similarity based few-shot video classifier with attention-based aggregation.

One or more embodiments of the present invention are directed to using a cosine similarity layer (instead of a linear layer) for few-shot video classification tasks. For the video classification task, capturing the specific ordering of frames in a sequence is also important. Accordingly, one or more embodiments of the present invention propose a new self-attention-based Transformer encoder to extract a video feature vector for the video example by considering the frame-level image feature vectors.

Accordingly, one or more embodiments of the present invention provide an end-to-end network based on a Transformer encoder based video feature extractor and cosine similarity based classifier for the few-shot video classification task.

One or more embodiments provide a Transformer encoder to form a video-level feature extractor for the cosine similarity based classifier.

Properly scaling the cosine similarity score in a softmax loss function can play a role in designing an effective cosine similarity based few-shot video classification network.

These and other features of the present invention are described in further detail hereinbelow.

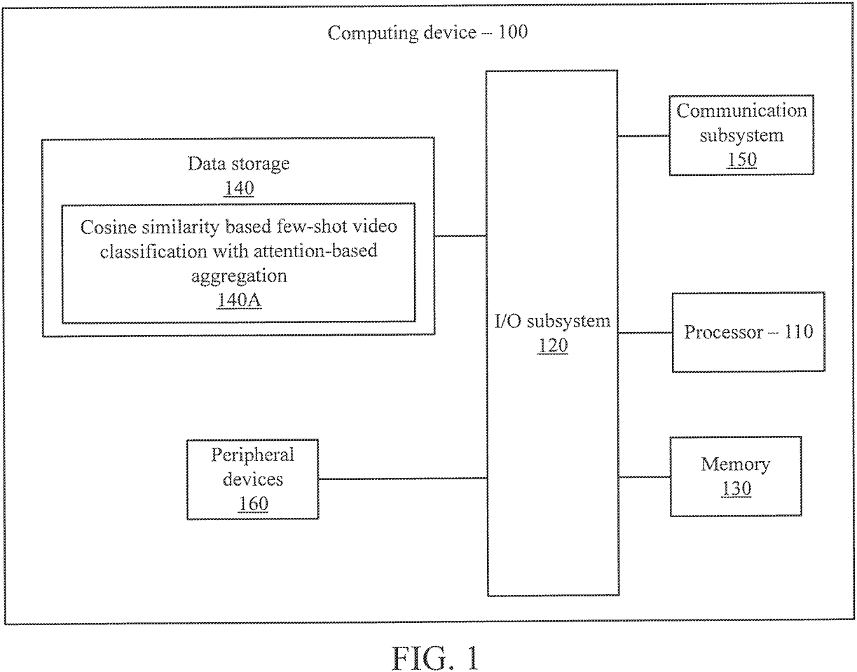

FIG. 1 is a block diagram showing an exemplary computing device 100, in accordance with an embodiment of the present invention. The computing device 100 is configured to perform cosine similarity based few-shot video classification with attention-based aggregation.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor- based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc. ) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for cosine similarity based few-shot video classification with attention-based aggregation. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

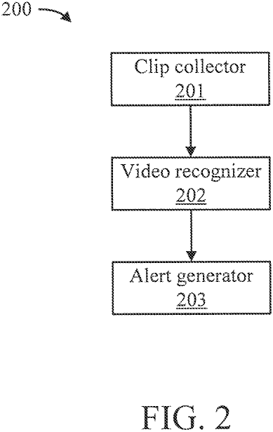

FIG. 2 shows an exemplary system 200 for video classification, in accordance with an embodiment of the present invention.

The system 200 includes a clip collector 201, a video recognizer 202, and an alert generator 203.

The clip collector 201 takes camera feeds from locations of interest. From the video or camera feeds, individual frames are extracted and multiple consecutive frames form a clip. Each clip is sent to the video recognizer 202.

The video recognizer 202 takes a video clip and classifies it to one of predefined classes of interest. Afterwards, it sends the clip with class information to the alert generator 203.

The alert generator 203 generates an alert whenever it receives a video clip from one of the predefined classes of interest.

It is to be appreciated that one of the advantageous features of the present invention includes building a video classification model when only a few examples are available per novel predefined classes of interest.

A description will now be given of the present invention, in accordance with an embodiment of the present invention.

In the few-shot video classification setting, we have ample labeled examples available for classes from the base or training set, C_{base}. However, we have only a few labeled examples from the novel or test set, Cₙₒᵥₑₗ. The classes in C_{base} are distinct from the classes in Cₙₒᵥₑₗ, i.e., there is no overlapping of classes between these two sets. Now, the main objective is to learn concept in the novel classes (having few examples) by leveraging the ample base class examples, that can generalize well to novel classes. Specifically, in a c-way k-shot problem, there are k examples available for each of the c novel classes in the support-set, where k is usually a small integer (< 10). The query-set includes Q samples per c classes and the goal is to classify the c x Q videos in one of the c novel classes.

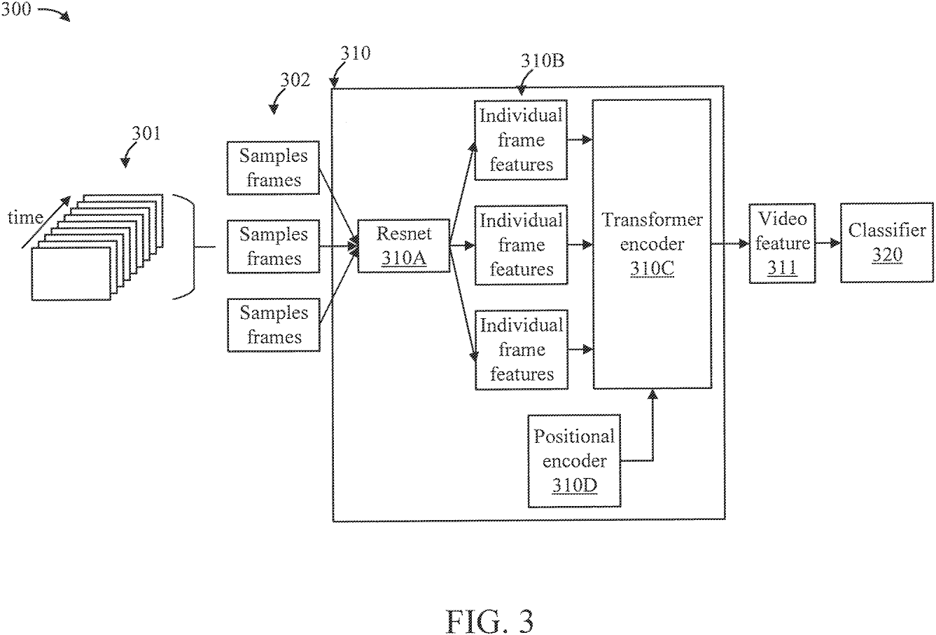

FIG. 3 is a block diagram showing a few-shot classification pipeline 300, in accordance with an embodiment of the present invention.

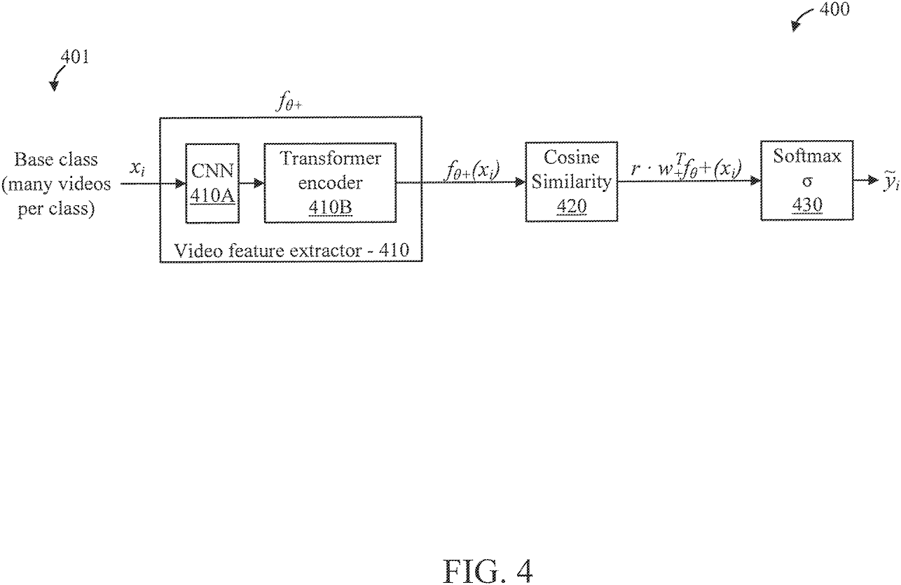

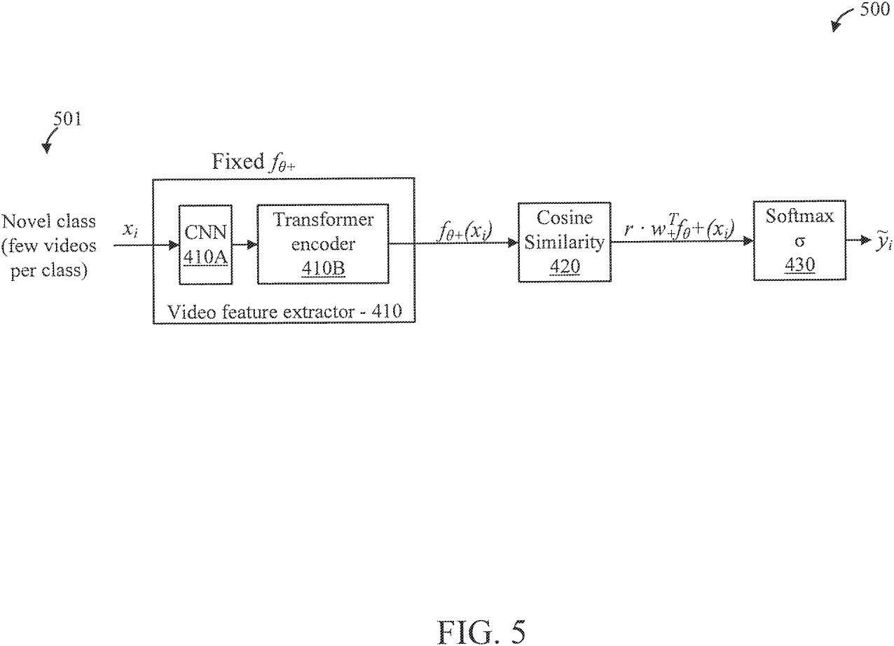

The few-shot video recognition network has the following two parts: (i) a video feature extractor 310 and (ii) a classifier 320. The video feature extractor 310 is utilized to obtain discriminative features from the input video fed into the classifier layer 320 to get individual class probability scores. The parameters of this end-to-end network are learned in two phases: (a) pre-training (see FIG. 4) and (b) few-shot adaptation (see FIG. 5). In the pre-training phase, the video feature extractor 310 is first trained on a large corpus of labeled data from the base classes. In the few-shot adaptation phase, the classifier layer 320 is fine-tuned on a smaller set of labeled data from the support-set of the novel classes for the specific few-shot action recognition task.

A further description will now be given regarding the video feature extractor 310, in accordance with an embodiment of the present invention.

The video feature extractor 310 is used to generate a compact representation of the input video clip, a raw video often includes hundreds of frames. Processing all of them takes a longer time. In addition, there is a lot of redundant information among the consecutive frames. As a result, we use the sparse sampling method as a preprocessing step for video inputs.

The video feature extractor 310 includes a Resnet 310A, individual frame features 310B, a transformer encoder 310C, and a positional encoder 310D.

We break the video clip into T equal-sized segments and fetch a random frame from each segment. Thus, each video can be represented by a fixed number of T frames xⱼ = {f₁,f₂, ...,f_{T}}, where fⱼ is the randomly selected frame from the j-th segment. Now, because of the sparse sampling, the sampled frames cover the original time range and long-term temporal information is preserved, while redundant spatio-temporal information is greatly reduced.

Now, given an input sequence xⱼ = {f₁, f₂, ...,f_{T}}, we encode each frame fⱼ with a CNN backbone (i.e., ResNet)f_{cnn} into feature f_{cnn}(fⱼ), which results in a sequence of feature vectors f_{cnn}(xⱼ) = {f_{cnn}(f₁), f_{cnn}(f₂), ..., f_{cnn}(f_{T}) }. We use activation before the last fully connected layer of a ResNet network as the feature embedding. Now, if d is the feature embedding dimension of the ResNet network, then the dimension of the video feature embedding is T x d.

A further description will now be given regarding the transformer encoder 310C, in accordance with an embodiment of the present invention.

Now, there are many ways to form a video level presentation. A popular way is to take an average over the temporal dimension of the extracted per frame embedding. However, the averaging strategy may not work well when we are interested in the fine-grained level actions which are sensitive to the position of the individual frames. To solve this issue, we propose to employ a transformer encoder 310C.

The transformer encoder 310C takes the sequence of feature vectors f_{cnn}(xⱼ) = {f_{cnn}(f₁), f_{cnn}(f₂), ..., f_{cnn}(f_{T}) } as input tokens. The transformer encoder 310C has a permutation-equivariant architecture, i.e., it produces the same output permuted if the input is permuted. Thus, transformers are suitable for processing sets. To apply transformers for processing a sequence of ordered feature vectors, we add learnable positional encodings 310D to the tokens before being processed by the transformer encoder 310C.

Herein, two variants are used to generate an embedding for the class prediction. First, like BERT, we add a “classification token” (CLS token in short) that is added to the input sequence and the output feature vector of the CLS token is used as the final embedding for the class prediction. Second, an average of the output feature vector of all tokens is taken as the final embedding for the class prediction. This final feature embedding is denoted as f_{θ}(xᵢ) herein.

A description will now be given regarding the classifier 320, in accordance with an embodiment of the present invention.

Finally, the classifier 320 takes f_{θ}(xᵢ) and maps it to a classification prediction. The classifier 320 is implemented by a fully connected layer.

A description will now be given regarding pre-training and few-shot adaptation states, in accordance with an embodiment of the present invention.

In the pre-training stage, a video feature extractor 310 followed by a classifier 320 is trained end-to-end from scratch using the training samples in the base classes. Typically, a linear classifier is utilized for the classifier 320. The linear classifier includes a linear layer with weight matrix W ∈ R^{d x} ^{c} followed by a softmax function δ to calculate the class probability score. First, the raw classification score S is calculated by taking the dot product between the weight matrix W and the extracted feature f_{θ}(xᵢ) as follows:

$$S = {W}^{T} {f}_{θ} \left({x}_{i}\right)$$

Then, the softmax function is applied to the raw classification score S to calculate the class probability score yᵢ.

In one or more embodiments of the present invention, instead of a linear classifier, it is proposed to utilize a distance-based classifier that explicitly reduces intra-class variation among features during the training. A cosine similarity function is incorporated between feature representations and classification weight vectors to compute raw classification scores.

FIG. 4 shows an overview of a pre-training stage 400, in accordance with an embodiment of the present invention. The pre-training stage 400 involves a base class (having many videos per class) 401, a video feature extractor 410, a cosine similarity element 420, and a softmax function 430. The video feature extractor 410 includes a convolutional neural network (CNN) 410A and a transformer encoder 410B.

Regarding the cosine similarity element 420, the following applies:

$${W}_{+} = \left[{w}_{1} , {w}_{2} , … , {w}_{c}\right] ∈ {ℝ}^{d x c} .$$

Regarding the softmax function 430, the following applies:

$${\tilde{y}}_{i} = σ \left(r ⋅ {W}_{+}^{T} {f}_{θ} + \left({x}_{i}\right)\right)$$

Here, for an extracted feature f_{θ}+(xᵢ) and weight matrix W₊=[w₁,w₂, ..., w_{c}], the similarity scores [si_{,i}, s_{i,2}, ..., s_{i,c}] for all c classes are obtained by calculating its cosine similarity to each weight vector [w₁, w₂, ..., w_{c}], where:

$${s}_{i , j} = \frac{{f}_{θ} + {\left({x}_{i}\right)}^{T} {w}_{j}}{\left‖{f}_{θ} + \left({x}_{i}\right)\right‖ \left‖{w}_{j}\right‖}$$

Afterwards, these similarity scores are normalized with a softmax function to obtain the prediction probability for each class as follows:

$${p}_{z} = \frac{exp \left(τ ⋅ {s}_{i , z}\right)}{{\sum }_{j = 1}^{c} exp \left(τ ⋅ {s}_{i , j}\right)} f o r z ϵ 1 , … , c$$

where we multiply the cosine similarity by a scalar value τ, which is a hyperparameter. It has been found that by tuning τ properly, the proposed network can achieve state-of-the-art accuracy.

During training, p_{z} = [p₁, p₂, ..., p_{c}] and the corresponding ground-truth class label yᵢ are used to optimize the model using a cross-entropy loss as follows:

$$L = - {\sum }_{z = 1}^{c} 1 \left(z = = {y}_{i}\right) log {p}_{z}$$

A description will now be given regarding few-shot adaptation, in accordance with an embodiment of the present invention.

FIG. 5 shows an overview of a few-shot adaptation stage 500, in accordance with an embodiment of the present invention. The few-shot adaptation stage 500 involves a novel class (having few videos per class) 501, a video feature extractor 410, a cosine similarity element 420, and a softmax function 430. The video feature extractor 410 includes a convolutional neural network (CNN) 410A and a transformer encoder 410B.

Regarding the cosine similarity element 420, the following applies:

$${W}_{+} = \left[{w}_{1} , {w}_{2} , … , {w}_{c}\right] ∈ {ℝ}^{d x c} .$$

Regarding the softmax function 430, the following applies:

$${\tilde{y}}_{i} = σ \left(r ⋅ {W}_{+}^{T} {f}_{θ} + \left({x}_{i}\right)\right)$$

Once the video feature extractor 410 is learned in the pre-training stage 400, the support set data is utilized in the few-shot adaptation phase 500 to train a classifier 420 to recognize novel classes 501 during test case scenarios. In this stage, the network parameter of the feature extractor f_{θ+} is kept fixed while the classifier 420 is trained using the few labeled support set examples of the novel classes 501. Here, only the weight matrix W₊ ∈ R^{d x c} has been updated during the few-shot adaptation stage 500.

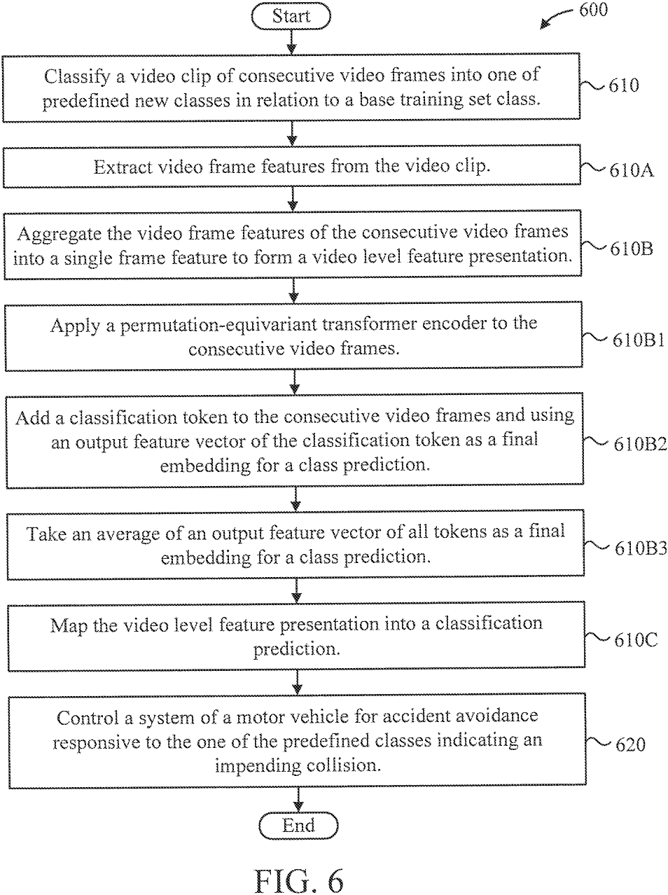

FIG. 6 is a flow diagram showing an exemplary method 600 for cosine-similarity based few-shot classification with attention-based aggregation, in accordance with an embodiment of the present invention.

At block 610, classify a video clip of consecutive video frames into one of predefined new classes in relation to a base training set class.

In an embodiment, block 610 can include one or more of blocks 610A through 610C.

At block 610A, extract video frame features from the video clip.

At block 610B, aggregate the video frame features of the consecutive video frames into a single frame feature to form a video level feature presentation.

In an embodiment, block 610B can include one or more of blocks 610B1 through 610B3.

At block 610B1, apply a permutation-equivariant transformer encoder to the consecutive video frames.

At block 610B2, add a classification token to the consecutive video frames and using an output feature vector of the classification token as a final embedding for a class prediction.

At block 610B3, take an average of an output feature vector of all tokens as a final embedding for a class prediction.

At block 610C, map the video level feature presentation into a classification prediction.

At block 620, control a system of a motor vehicle for accident avoidance responsive to the one of the predefined classes indicating an impending collision. The system of the motor vehicle can be any of a braking system, an accelerating system, a steering system, a stability system, and so forth.

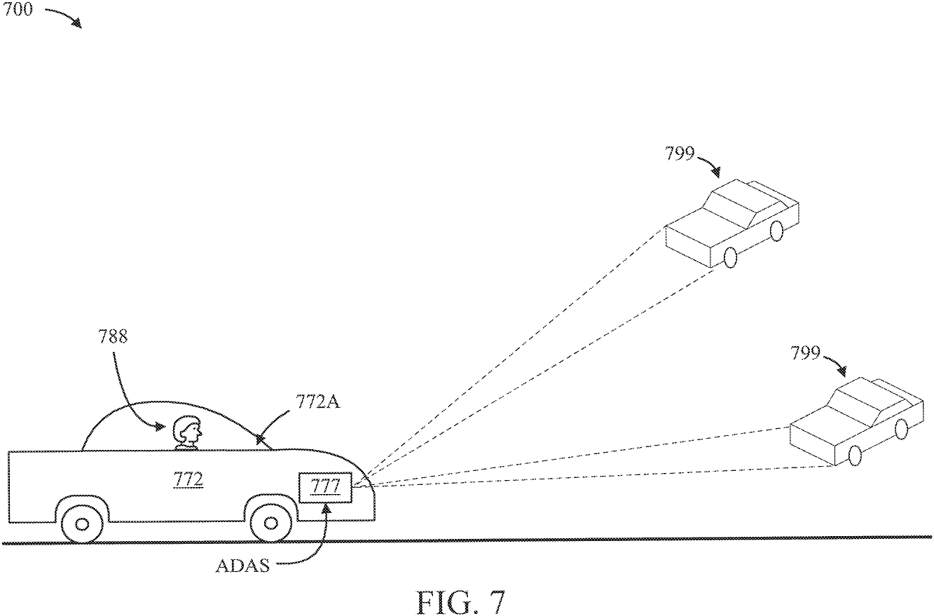

FIG. 7 is a block diagram showing an exemplary environment 700 to which the present invention can be applied, in accordance with an embodiment of the present invention.

In the environment 700, a user 788 is located in a scene with multiple objects 799, each having their own locations and trajectories. The user 788 is operating a vehicle 772 (e.g., a car, a truck, a motorcycle, etc.) having an ADAS 777.

The ADAS 777 receives class prediction such as impending collision.

Responsive to the class prediction, a vehicle controlling decision is made. To that end, the ADAS 777 can control, as an action corresponding to a decision, for example, but not limited to, steering, braking, and accelerating systems.

Thus, in an ADAS situation, steering, accelerating/braking, friction (or lack of friction), yaw rate, lighting (hazards, high beam flashing, etc.), tire pressure, turn signaling, and more can all be efficiently exploited in an optimized decision in accordance with the present invention.

The system of the present invention (e.g., system 777) may interface with the user through one or more systems of the vehicle 772 that the user is operating. For example, the system of the present invention can provide the user information through a system 772A (e.g., a display system, a speaker system, and/or some other system) of the vehicle 772. Moreover, the system of the present invention (e.g., system 777) may interface with the vehicle 772 itself (e.g., through one or more systems of the vehicle 772 including, but not limited to, a steering system, a braking system, an acceleration system, a steering system, a lighting (turn signals, headlamps) system, etc.) in order to control the vehicle and cause the vehicle 772 to perform one or more actions. In this way, the user or the vehicle 772 itself can navigate around these objects 799 to avoid potential collisions there between. The providing of information and/or the controlling of the vehicle can be considered actions that are determined in accordance with embodiments of the present invention.

While described with respect to an ADAS, the present invention can be applied to a myriad of applications involving, e.g., a trajectory. For example, navigation involving automated agents, robots, assistive technologies for blind people, and/or so forth can be exploited by embodiments of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures llustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
classifying a video clip of consecutive video frames into one of predefined new classes in relation to a base training set class; and
controlling a system of a motor vehicle for accident avoidance responsive to the one of the predefined classes indicating an impending collision,
wherein said classifying step comprises:
extracting video frame features from the video clip;
aggregating the video frame features of the consecutive video frames into a single frame feature to form a video level feature presentation; and
mapping, by a distance-based classifier, the video level feature presentation into a classification prediction based on cosine similarity.

2. The computer-implemented method of claim 1, wherein the system of the motor vehicle is selected from the group consisting of a braking system, an accelerating system, a steering system, and a stability system.

3. The computer-implemented method of claim 1, wherein said aggregating step comprises applying a permutation-equivariant transformer encoder to the consecutive video frames.

4. The computer-implemented method of claim 1, wherein said aggregating step comprises adding a classification token to the consecutive video frames and using an output feature vector of the classification token as a final embedding for a class prediction.

5. The computer-implemented method of claim 1, wherein said aggregating step comprises taking an average of an output feature vector of all classification tokens as a final embedding for a class prediction.

6. The computer-implemented method of claim 1, wherein said classification step is performed by a fully connected layer of a classifier.

7. The computer-implemented method of claim 6, wherein an input layer size of the classifier is a dimension of the video level feature presentation, and wherein an output layer size is a number of base classes.

8. The computer-implemented method of claim 6, wherein an input layer size of the classifier is a dimension of the video level feature representation, and wherein an output layer size is a number of novel classes.

9. The computer-implemented method of claim 1, wherein said classification step uses the distance-based classifier to reduce intra-class variation among features during training.

10. The computer-implemented method of claim 9, wherein the distance-based classifier incorporates a cosine similarity function between the features and classification weight vectors to compute raw classification scores.

11. The computer-implemented method of claim 9, where said classification step involves normalizing a weight matrix and an extracted feature prior to applying a dot product operation therebetween.

12. The computer-implemented method of claim 1, wherein a training stage comprises obtaining similarity scores for base training set classes with respect to cosine similarity to a weight vector.

13. The computer-implemented method of claim 1, wherein a training stage comprises using a prediction probability for each class and corresponding ground truth class labels to optimize a model using a cross-entropy loss.

14. The computer-implemented method of claim 1, wherein a training stage comprises keeping the video extractor fixed while a network parameter of the distance-based classifier is fine-tuned using sample video clips from novel classes.

15. A computer program product, the computer program product comprising a non-transitory computer readable storage medium having program instructions embodied therewith, the program instructions executable by a computer to cause the computer to perform a method comprising:
classifying, by a hardware processor of the computer, a video clip of consecutive video frames into one of predefined new classes in relation to a base training set class; and
controlling, by the hardware processor, a system of a motor vehicle for accident avoidance responsive to the one of the predefined classes indicating an impending collision,
wherein said classifying step comprises:
extracting video frame features from the video clip;
aggregating the video frame features of the consecutive video frames into a single frame feature to form a video level feature presentation; and
mapping, by a distance-based classifier implemented by the hardware processor, the video level feature presentation into a classification prediction based on cosine similarity.

16. The computer-implemented method of claim 15, wherein said aggregating step comprises applying a permutation-equivariant transformer encoder to the consecutive video frames.

17. The computer-implemented method of claim 15, wherein said aggregating step comprises adding a classification token to the consecutive video frames and using an output feature vector of the classification token as a final embedding for a class prediction.

18. The computer-implemented method of claim 15, wherein said aggregating step comprises taking an average of an output feature vector of all classification tokens as a final embedding for a class prediction.

19. The computer-implemented method of claim 15, wherein said classification step is performed by a fully connected layer of a classifier.

20. A computer processing system, comprising:
a memory device for storing program code; and
a hardware processor operatively coupled to the memory device for running the program code to:
perform a classification of a video clip of consecutive video frames into one of predefined new classes in relation to a base training set class; and
control a system of a motor vehicle for accident avoidance responsive to the one of the predefined classes indicating an impending collision,
wherein the classification comprises:
extracting video frame features from the video clip;
aggregating the video frame features of the consecutive video frames into a single frame feature to form a video level feature presentation; and
mapping, by a distance-based classifier implemented by the hardware processor, the video level feature presentation into a classification prediction based on cosine similarity.
